(19) United States
(12) Patent Application Publication
(10) Pub. No.: US 2024/0236488 A1
(43) Pub. Date: Jul. 11, 2024

(54) IMAGING DEVICE AND IMAGING METHOD

(71) Applicant: Sony Semiconductor Solutions Corporation, Kanagawa (JP)

(72) Inventors: Takashi Fujikawa, Kanagawa (JP); Yukiyasu Tatsuzawa, Kanagawa (JP); Atsushi Kitahara, Kanagawa (JP); Takao Konishi, Kanagawa (JP); Nozomi Iwaya, Kanagawa (JP); Kenya Furuichi, Kanagawa (JP)

(21) Appl. No.: 18/561,443

(22) PCT Filed: Mar. 7, 2022
(86) PCT No.: PCT/JP22/09672

§ 371 Date: Nov. 16, 2023

(30) Foreign Application Priority Data
Jul. 9, 2021 (JP) 2021-114033

(51) Int. Cl. H04N 23/68

(52) U.S. Cl. CPC H04N 23/6811; H04N 23/6812

(57) ABSTRACT

A motion of a subject is detected, and an image is captured at timing desired by a user. An imaging device includes a first sensor, a position information acquiring unit, a second sensor, an acquisition condition generating unit, and a control unit. The first sensor acquires object information that is information regarding an object. The position information acquiring unit acquires position information that is information instructing the position of the object at the time of acquiring the object information. The second sensor acquires motion information that is information regarding the motion of the object. The acquisition condition generating unit generates an acquisition condition of the object information on the basis of the acquired position information and the acquired motion information. The control unit performs control to cause the first sensor to acquire the object information on the basis of the generated acquisition condition.

### FIELD

The present disclosure relates to an imaging device and an imaging method.

### BACKGROUND

In an imaging device that acquires an image of a subject, there is proposed an imaging device that automatically captures an image at timing desired by a user (see, for example, Patent Literature 1.). This imaging device determines whether or not the subject performs a motion instructed by the user while detecting an imaging environment. This determination is performed by an image processing unit on the basis of images continuously generated by an imaging element. As a result, in a case where the imaging environment does not satisfy a predetermined condition, an imaging operation is performed in a first imaging mode at timing when the subject performs the motion instructed by the user. Thereafter, the imaging operation is performed in a second imaging mode at timing when the detected imaging environment satisfies the predetermined condition.

### CITATION LIST

### Patent Literature

Patent Literature 1: JP 2020-120294 A

### SUMMARY

### Technical Problem

However, in the above conventional technology, images for detection of the motion of the subject are generated using the imaging element that captures images the subject. Therefore, there is a problem that it is difficult to detect the motion of the subject in a case where the subject moves at a high speed or the like. For example, in a case where the subject moves at a higher speed than a frame rate of the imaging element, it is difficult to capture an image at desired timing, and there is a problem that sufficient accuracy cannot be obtained even when the image is captured with prediction.

Therefore, the present disclosure proposes an imaging device and an imaging method for detecting a motion of a subject and capture an image at timing desired by a user even in a case where the subject moves at a high speed.

### Solution to Problem

The present disclosure has been conceived to solve the problem described above, and the aspect thereof is an imaging device includes: a first sensor that acquires object information, the object information being information regarding an object; a position information acquiring unit that acquires position information, the position information being information instructing a position of the object at time of acquiring the object information; a second sensor that acquires motion information, the motion information being information regarding a motion of the object; an acquisition condition generating unit that generates an acquisition condition of the object information on the basis of the position information that has been acquired and the motion information that has been acquired; and a control unit that performs control to cause the first sensor to acquire the object information on the basis of the acquisition condition that has been generated.

### BRIEF DESCRIPTION OF DRAWINGS

FIG. 1 is a diagram illustrating a configuration example of an imaging device according to a first embodiment of the disclosure.

FIG. 2A is a diagram illustrating an example of position information according to an embodiment of the disclosure.

FIG. 2B is a diagram illustrating an example of position information according to the embodiment of the disclosure.

FIG. 3 is a diagram illustrating an example of imaging processing according to the first embodiment of the present disclosure.

FIG. 4 is a diagram illustrating an example of an imaging method according to the first embodiment of the disclosure.

FIG. 5 is a diagram illustrating a configuration example of an imaging device according to a second embodiment of the disclosure.

FIG. 6A is a diagram illustrating an example of setting of an imaging size according to the second embodiment of the disclosure.

FIG. 6B is a diagram illustrating an example of setting of an imaging size according to the second embodiment of the disclosure.

FIG. 7 is a diagram illustrating a configuration example of an imaging device according to a third embodiment of the disclosure.

FIG. 8 is a diagram illustrating a configuration example of an imaging device according to a fourth embodiment of the disclosure.

FIG. 9 is a diagram illustrating a configuration example of an imaging device according to a fifth embodiment of the disclosure.

FIG. 10 is a diagram illustrating a configuration example of an imaging device according to a sixth embodiment of the disclosure.

FIG. 11 is a diagram illustrating a configuration example of an imaging device according to a seventh embodiment of the disclosure.

### DESCRIPTION OF EMBODIMENTS

Hereinafter, embodiments of the present disclosure will be described in detail on the basis of the drawings. Description will be given in the following order. Note that in each of the following embodiments, the same parts are denoted by the same symbols, and redundant description will be omitted.
1. First Embodiment
2. Second Embodiment
3. Third Embodiment
4. Fourth Embodiment
5. Fifth Embodiment
6. Sixth Embodiment
7. Seventh Embodiment

### 1. First Embodiment

### [Configuration of Imaging Device]

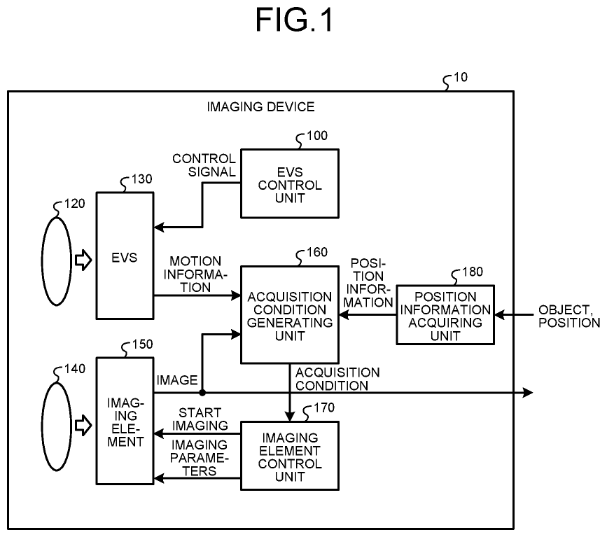

FIG. 1 is a diagram illustrating a configuration example of an imaging device according to a first embodiment of the disclosure. The drawing is a block diagram illustrating a configuration example of an imaging device 10. The imaging device 10 is a device that generates an image of a subject while detecting motion of a subject. The imaging device 10 includes an EVS 130, an EVS control unit 100, an acquisition condition generating unit 160, a position information acquiring unit 180, an imaging element 150, an imaging element control unit 170, and imaging lenses 120 and 140.

The EVS 130 is an imaging element that detects a change in luminance of a subject and generates an image. The EVS 130 is referred to as an event-driven sensor or an event-based vision sensor (EVS) and includes a pixel array unit in which pixels for detecting a change in luminance of incident light are arranged in a two-dimensional matrix shape. The EVS 130 extracts a change in luminance by the pixel array unit and generates an image of only a portion where the luminance has changed in the subject. The above portion where the luminance of the subject changes represents a portion of the subject that is moving. The EVS 130 detects this moving portion of the subject as event data.

The EVS 130 in the drawing acquires event data of an object to be photographed in the imaging element 150 described later as motion information of the object. The EVS 130 outputs the acquired motion information to the acquisition condition generating unit 160.

Since the EVS 130 extracts only the change in luminance of the subject, it is possible to output at a higher dynamic range and a higher frame rate than a general imaging element does. Furthermore, the EVS 130 can reduce the data amount of an output image as compared with an image generated by a normal imaging element. This is because an output image of the EVS 130 includes only a portion where the luminance changes.

The EVS control unit 100 controls the EVS 130. The EVS control unit 100 controls the EVS 130 by outputting a control signal. The EVS control unit 100 controls the EVS 130 to cause to generate and output event data in a predetermined cycle.

The imaging element 150 generates an image of the subject. The imaging element 150 includes a pixel array unit in which pixels for detecting incident light are arranged in a two-dimensional matrix and generates an image based on the amount of incident light in a predetermined exposure period. Note that the imaging element 150 in the drawing generates and acquires object information, which is information regarding an object, as an image of a subject corresponding to the object. The image generated by the imaging element 150 is output to the acquisition condition generating unit 160. Furthermore, the imaging element 150 outputs the generated image to an external device as an output image of the imaging device 10.

The imaging element control unit 170 controls the imaging element 150. The imaging element control unit 170 controls the imaging element 150 by outputting a control signal that instructs start of imaging to the imaging element 150. The acquisition condition generating unit 160 to be described later outputs the acquisition time of the image of the object as an acquisition condition. The imaging element control unit 170 controls the start of imaging on the basis of the acquisition condition. Note that the imaging element control unit 170 is an example of a control unit described in the claims.

Furthermore, the imaging element control unit 170 outputs imaging parameters in the imaging element 150. The imaging parameters correspond to, for example, an exposure time, sensitivity (gain) of an image signal included in an image, and others. Note that the imaging element 150 in the drawing is based on the premise that capturing an imaging is performed with an electronic shutter. The acquisition condition generating unit 160 further outputs the above imaging condition of the object as a second acquisition condition. The imaging element control unit 170 outputs imaging parameters based on the second acquisition condition to the imaging element 150 to cause to generate an image.

The position information acquiring unit 180 acquires position information that is information instructing the position of the object. The position information acquiring unit 180 acquires, for example, an object and an imaging position of the object from the user of the imaging device 10. For example, the user of the imaging device 10 can input the object by an image of the object or others. Furthermore, the user of the imaging device 10 can input the position information by inputting the position of the object using, for example, a touch panel or the like displaying an image captured in advance. The position information acquiring unit 180 acquires the object and the position information of the object by such input by the user or the like. The acquired position information is output to the acquisition condition generating unit 160.

The acquisition condition generating unit 160 generates an acquisition condition of the object information on the basis of the motion information output from the EVS 130 and the position information output from the position information acquiring unit 180. The acquisition condition generating unit 160 in the drawing specifies the object and the imaging position of the object on the basis of the position information and generates the acquisition time of the image of the object as an acquisition condition on the basis of the motion information. The acquisition time of the image of the object corresponds to the imaging time of the image of the object. The generated acquisition condition is output to the imaging element control unit 170. Note that the object can be specified by, for example, artificial intelligence (AI) processing such as machine learning.

Furthermore, the acquisition condition generating unit 160 in the drawing further generates imaging parameters on the basis of a previously acquired image that is an image having been acquired in advance by the imaging element 150. The acquisition condition generating unit 160 further outputs the imaging parameters as the second acquisition condition to the imaging element control unit 170.

The imaging lens 120 is a lens that forms an image of the subject on the pixel array unit of the EVS 130. The imaging lens 140 forms an image of the subject on the imaging element 150.

Note that the imaging element 150 is an example of the first sensor described in the claims. The EVS 130 is an example of the second sensor described in the claims. As the second sensor, a sensor having a higher frame rate than that of the first sensor can be used.

### [Position Information]

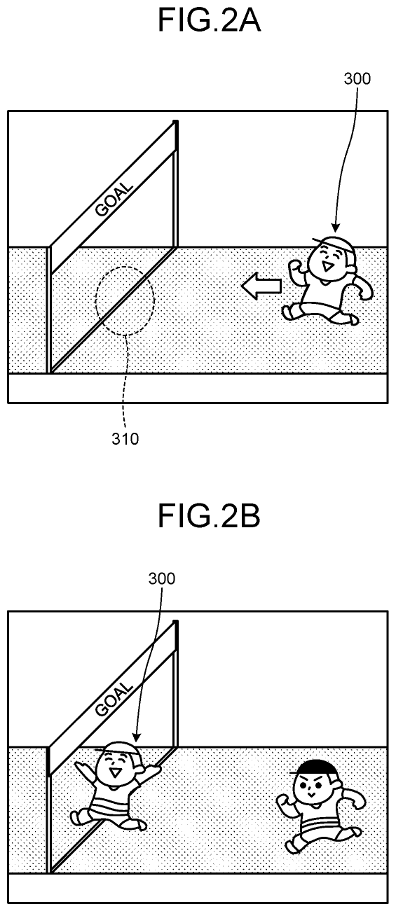

FIGS. 2A and 2B are diagrams illustrating an example of position information according to an embodiment of the disclosure. The drawing illustrates an example of position information of an object.

In FIG. 2A, a case is assumed where the user of the imaging device 10 desires to acquire an image when a “child” in a competition reaches a “goal line”. An outlined arrow in the drawing indicates the direction of the motion of the “child”. In this case, the user of the imaging device 10 inputs the “child” in the drawing, as an object 300, to the position information acquiring unit 180 and inputs a position 310 on the “goal line” to the position information acquiring unit 180 as the imaging position. The position information acquiring unit 180 acquires the position information on the basis of the input of the user of the imaging device 10 and outputs the position information to the acquisition condition generating unit 160.

The acquisition condition generating unit 160 predicts the time when the object 300 reaches the position 310 on the basis of the motion information from the EVS 130. Next, the acquisition condition generating unit 160 generates an acquisition time of an image of the object 300 on the basis of the time when the object 300 reaches the position 310. For example, the start time of exposure in the imaging element 150 can be applied to the acquisition time. The acquisition condition generating unit 160 outputs the acquisition time of the image to the imaging element control unit 170 as an acquisition condition. Furthermore, the acquisition condition generating unit 160 generates imaging parameters in the vicinity of the position 310, for example, an exposure time of the image, on the basis of the previously acquired image output by the imaging element 150. The acquisition condition generating unit 160 outputs the imaging parameters to the imaging element control unit 170 as a second acquisition condition.

The imaging element control unit 170 outputs and sets the imaging parameters from the acquisition condition generating unit 160 to the imaging element 150.

In FIG. 2B, when the object 300 reaches the imaging position, the imaging element 150 starts imaging. The user of the imaging device 10 can obtain an image of the object 300 at desired timing.

### [Imaging Processing]

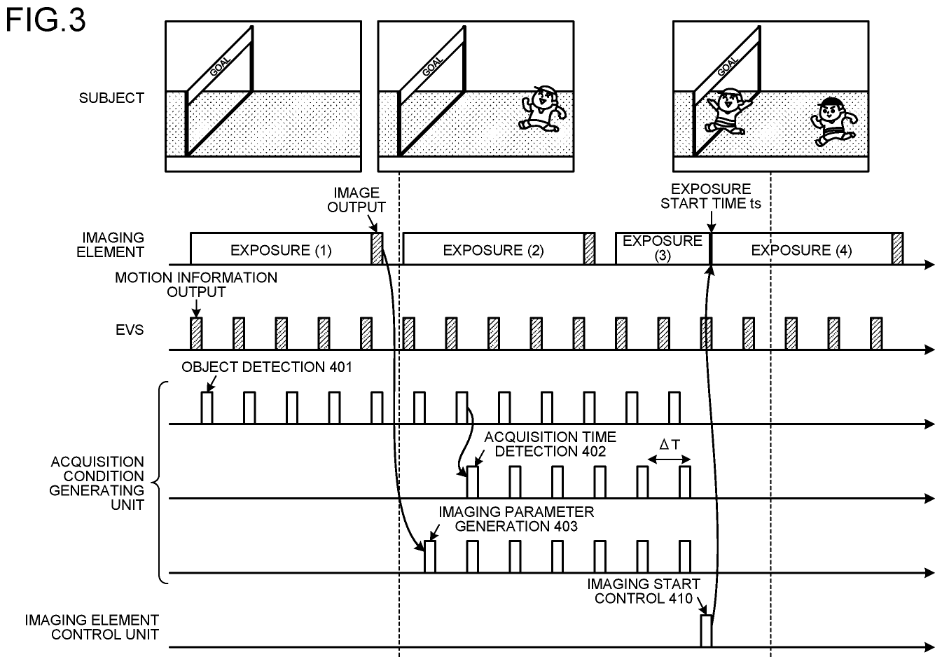

FIG. 3 is a diagram illustrating an example of imaging processing according to the first embodiment of the present disclosure. The diagram is a timing chart illustrating an example of imaging processing in the imaging device 10. In the diagram, the “subject” illustrates images representing the state of the subject for each scene. A broken line under each image represents timing when an event of the image occurs. The “imaging element” represents processing of the imaging element 150. The “EVS” represents processing of the EVS 130. The “acquisition condition generating unit” represents processing of the acquisition condition generating unit 160. The “imaging control unit” represents processing of the imaging element control unit 170.

The imaging element 150 repeatedly exposes the subject to light. The “Exposure” in the portion of “imaging element” in the drawing represents exposure processing. Exposures performed sequentially are identified by the numbers in parentheses. After an exposure, an image generated by the exposure is output. A hatched rectangle in the portion of “imaging element” in the drawing represents this image output processing. The drawing illustrates an example of a case where the object 300 enters an image of a subject after the image output following exposure (1).

The EVS 130 repeatedly outputs the motion information. A hatched rectangle of the portion of “EVS” in the drawing represents this processing of motion information output. Motion information generated after the timing when the object 300 is included in the image of the portion of “imaging element” includes the object 300.

The acquisition condition generating unit 160 sequentially performs detection processing of the object 300 (object detection 401 in the drawing) on the motion information output from the EVS 130. In the object detection 401 after the timing when the object 300 is included in the image of the portion of “imaging element” described above, the object 300 is detected, and the detection result is output. After the object detection 401 in which the detection result of the object 300 is output, the acquisition condition generating unit 160 performs acquisition time detection 402. The acquisition time detection 402 generates an optical flow that is information regarding a temporal change of the position (coordinates) of the object 300. On the basis of this optical flow, the acquisition condition generating unit 160 can detect the acquisition time on the basis of a change in the position (coordinates) of the object 300 detected in the object detection 401. The acquisition time detection 402 is repeatedly performed, and the acquisition time is updated. In the drawing, ΔT represents an interval of the repeatedly performed acquisition time detection 402. In a case where the acquisition time detected in the acquisition time detection 402 is earlier than a time after ΔT, the acquisition condition generating unit 160 outputs the detected acquisition time as an acquisition condition to the imaging element control unit 170.

Furthermore, after the object detection 401 in which the detection result of the object 300 is output, the acquisition condition generating unit 160 performs processing of imaging parameter generation 403. The imaging parameter generation 403 is performed on the basis of a previously acquired image generated immediately before. In the drawing, the acquisition condition generating unit 160 generates imaging parameters on the basis of the image generated by the exposure (1). The acquisition condition generating unit 160 can also generate the imaging parameters on the basis of the motion information in addition to the previously acquired image. For example, in a case where the motion of the object is fast, the acquisition condition generating unit 160 generates a short exposure time as an imaging parameter. This is to suppress shaking (motion prioritized). Furthermore, for example, in a case where the motion of the object is slow, the acquisition condition generating unit 160 generates a relatively long exposure time as an imaging parameter. This is to improve the S/N ratio (image quality prioritized). The imaging parameter generation 403 is also repeatedly performed, and the imaging parameters are updated. The generated imaging parameter is output to the imaging element control unit 170 as the second acquisition condition.

The imaging element control unit 170 performs imaging start control 410 on the basis of the acquisition time output by the acquisition condition generating unit 160. In the imaging start control 410, the imaging element control unit 170 outputs and sets the imaging parameters to the imaging element 150 and instructs to start imaging. The drawing illustrates an example of a case where the imaging start time ts overlaps with exposure (3) in the imaging element 150. In this case, the exposure (3) of the imaging element 150 is stopped, and exposure (4) is newly started. In an image generated by the exposure (4), the object 300 has reached a position designated by the user of the imaging device 10. This image is used as an output image of the imaging device 10.

Note that, even in a case where the sight of the object 300 is lost due to camera shake or the like, the acquisition condition generating unit 160 can detect the object 300 again if within a certain period of time.

### [Imaging Method]

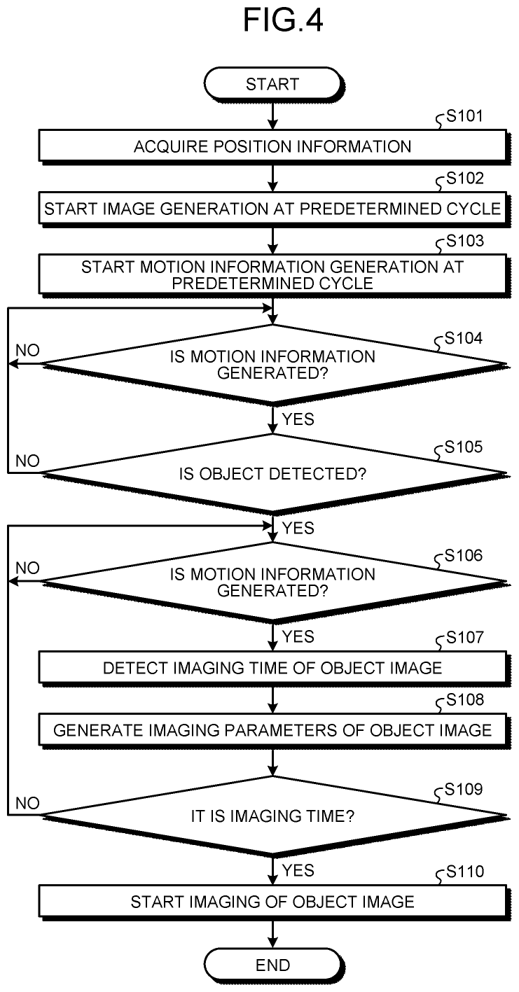

FIG. 4 is a diagram illustrating an example of an imaging method according to the first embodiment of the disclosure. The drawing is a flowchart illustrating an example of the imaging method in the imaging device 10. First, the position information acquiring unit 180 acquires position information from the user of the imaging device 10 (step S101). Next, the imaging element control unit 170 controls the imaging element 150 to start image generation at a predetermined cycle (step S102). Next, the EVS control unit 100 controls the EVS 130 to start motion information generation at a predetermined cycle (step S103).

Next, the acquisition condition generating unit 160 waits until motion information is generated by the EVS 130 (step S104). If the motion information is generated (step S104: Yes), the acquisition condition generating unit 160 determines whether or not the motion information includes the object 300 (step S105). If the object 300 is not detected from the motion information (step S105: No), the acquisition condition generating unit 160 returns to the processing of step S104. On the other hand, if the object 300 is detected from the motion information (step S105: Yes), the acquisition condition generating unit 160 proceeds to the processing of step S106.

In step S106, the acquisition condition generating unit 160 waits until the motion information is generated by the EVS 130 (step S106). If the motion information is generated (step S106: Yes), the acquisition condition generating unit 160 detects an imaging time of the object image on the basis of the motion information (step S107). Next, the acquisition condition generating unit 160 generates imaging parameters of the object image (step S108). Next, the acquisition condition generating unit 160 determines whether or not it is the imaging time (step S109). This determination can be made on the basis of whether the detected imaging time (acquisition time) arrives before detection of a subsequent imaging time. If it is not the imaging time (step S109: No), the acquisition condition generating unit 160 returns to the processing of step S106.

On the other hand, if the imaging time has arrived (step S109: Yes), the acquisition condition generating unit 160 starts imaging an object image (step S110). This can be performed by the acquisition condition generating unit 160 outputting an acquisition condition for starting imaging to the imaging element control unit 170. With the above processing, it is possible to capture an image of the object 300 desired by the user of the imaging device 10.

Note that the configuration of the imaging device 10 is not limited to this example. For example, in FIG. 1, an imaging element that generates an image at a higher frame rate than that of the imaging element 150 can be used instead of the EVS 130. In this case, the acquisition condition generating unit 160 detects the acquisition time on the basis of the image generated by the above imaging element. It is also possible to adopt a configuration in which the imaging device 10 detects the speed of camera shake. In this case, the acquisition condition generating unit 160 can correct the exposure time depending on the detected speed of the camera shake.

As described above, in the imaging device 10 according to the first embodiment of the present disclosure, the acquisition condition generating unit 160 detects the imaging time on the basis of the motion information of the object 300 generated by the EVS 130. As a result, even in a case where the object 300 moves at a high speed, an image of the object 300 can be captured at timing desired by the user of the imaging device 10.

### 2. Second Embodiment

The imaging device 10 according to the first embodiment acquires an image of the object 300. Meanwhile, an imaging device 10 according to a second embodiment of the present disclosure is different from that of the first embodiment in that an image obtained by changing the magnification of an object 300 is captured.

### [Configuration of Imaging Device]

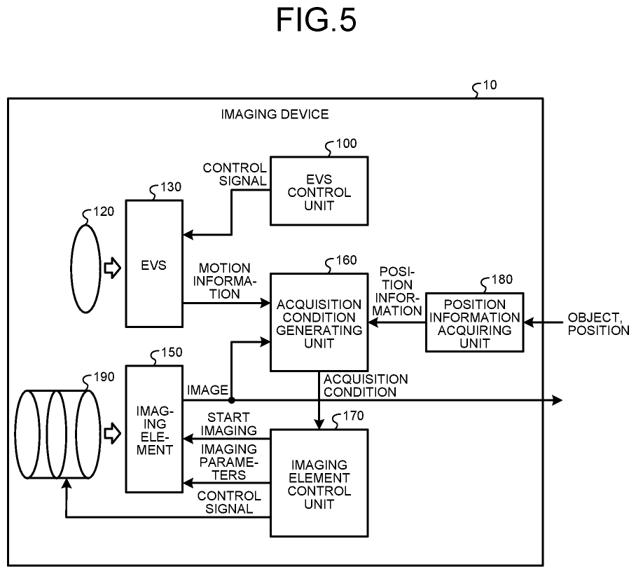

FIG. 5 is a diagram illustrating a configuration example of the imaging device according to the second embodiment of the disclosure. The drawing is a block diagram illustrating a configuration example of the imaging device 10, similarly to FIG. 1. The imaging device 10 in the drawing is different from the imaging device 10 in FIG. 1 in that an imaging lens 190 is included instead of the imaging lens 140.

The imaging lens 190 includes an optical zoom mechanism. The imaging lens 190 can change the zoom amount by adjusting the focal length on the basis of a control signal from an imaging element control unit 170. A user of the imaging device 10 in the drawing inputs the size of the object 300 to a position information acquiring unit 180 in advance. The position information acquiring unit 180 outputs information regarding the size of the object 300, in addition to position information, to an acquisition condition generating unit 160. The acquisition condition generating unit 160 generates a zoom amount depending on the size of the object 300 and outputs the zoom amount to the imaging element control unit 170 as a second acquisition condition. The imaging element control unit 170 outputs a control signal for adjusting to a focal length corresponding to the zoom amount to the imaging lens 190. As a result, an image of the object 300 having a size desired by the user of the imaging device 10 can be acquired.

### [Setting of Imaging Size]

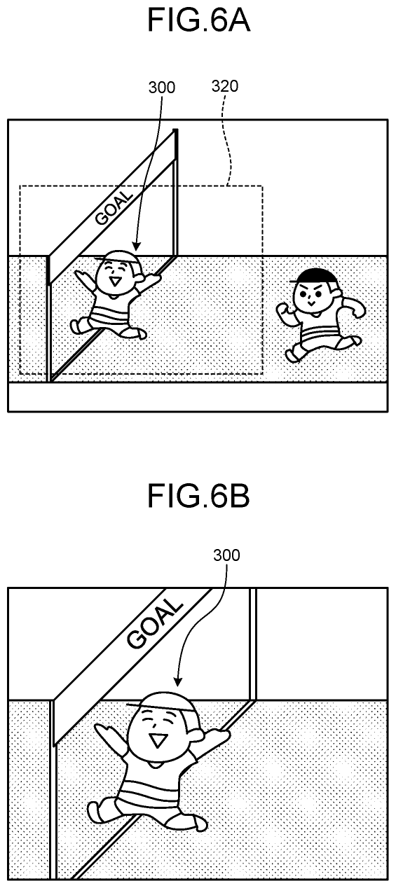

FIG. 6A illustrates an example of setting an angle of view (size) of the object 300 with respect to an image similar to that in FIG. 2B. This drawing illustrates an example of generating an object area 320 that is an area including the object 300. The acquisition condition generating unit 160 generates the object area 320, which is an area including the object 300, on the basis of an imaging size input by the user of the imaging device 10. The acquisition condition generating unit 160 further generates the zoom amount corresponding to the object area 320 and outputs the zoom amount to the imaging element control unit 170.

FIG. 6B illustrates an example of an image enlarged corresponding to the object area 320. An image around the object 300 is enlarged by the imaging lens 190, and an image is generated by the imaging element 150.

Note that the configuration of the imaging device 10 is not limited to this example. For example, a configuration including a digital zoom can be adopted. In this case, the imaging element 150 sets the object area 320 as a cropping size, deletes the area outside the cropping size from the captured image, enlarges the image within the cropping size, and generates an enlarged image of the object 300.

The configuration of the imaging device 10 other than the above is similar to the configuration of the imaging device 10 in the first embodiment of the present disclosure, and thus description thereof is omitted.

As described above, the imaging device 10 according to the second embodiment of the present disclosure can generate an image of the object 300 having a size desired by the user of the imaging device 10.

### 3. Third Embodiment

The imaging device 10 of the first embodiment described above captures still images. Meanwhile, an imaging device 10 according to a third embodiment of the present disclosure is different from that of the above first embodiment in that moving images are further captured.

### [Configuration of Imaging Device]

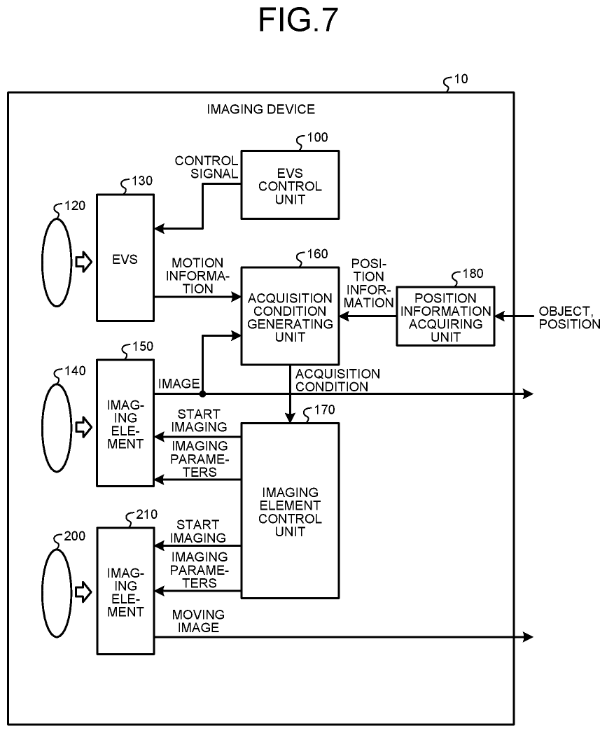

FIG. 7 is a diagram illustrating a configuration example of the imaging device according to the third embodiment of the disclosure. The drawing is a block diagram illustrating a configuration example of the imaging device 10, similarly to FIG. 1. The imaging device 10 in the drawing is different from the imaging device 10 in FIG. 1 in further including an imaging element 210 and an imaging lens 200.

Similarly to the imaging lens 190, the imaging lens 200 forms an image of a subject on the imaging element 210.

The imaging element 210 generates a moving image that is a plurality of images generated in time series. The imaging element 210 generates a moving image including an image of an object 300 and outputs the moving image to an external device of the imaging device 10.

The acquisition condition generating unit 160 in the drawing can generate the frame rate of the moving image in the imaging element 210 as an imaging parameter on the basis of the speed at which the object 300 moves and the amount of camera shake. The acquisition condition generating unit 160 outputs imaging parameters including the frame rate to the imaging element control unit 170 as a second acquisition condition.

The imaging element control unit 170 in the drawing outputs a control signal and the imaging parameters for instructing start of imaging to an imaging element 150 and further to the imaging element 210. As a result, the imaging element 210 can start capturing a moving image at the same imaging timing as that of the imaging element 150 and can generate a moving image corresponding to the set frame rate.

The configuration of the imaging device 10 other than the above is similar to the configuration of the imaging device 10 in the first embodiment of the present disclosure, and thus description thereof is omitted.

As described above, the imaging device 10 according to the third embodiment of the present disclosure can generate a moving image of the object 300 at timing desired by the user of the imaging device 10.

### 4. Fourth Embodiment

The imaging device 10 according to the first embodiment forms an image of a subject on the imaging element 150 by the imaging lens 140. Meanwhile, an imaging device 10 according to a fourth embodiment of the present disclosure is different from the above first embodiment in that a focal position of an imaging lens 140 is adjusted.

### [Configuration of Imaging Device]

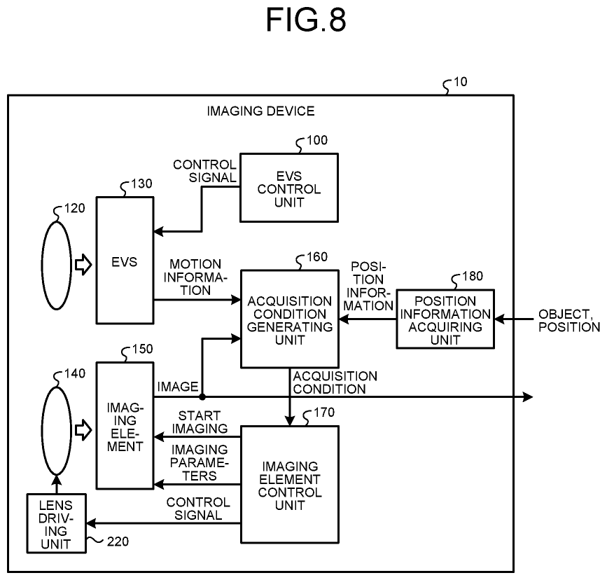

FIG. 8 is a diagram illustrating a configuration example of the imaging device according to the fourth embodiment of the disclosure. The drawing is a block diagram illustrating a configuration example of the imaging device 10, similarly to FIG. 1. The imaging device 10 in the drawing is different from the imaging device 10 in FIG. 1 in further including a lens driving unit 220.

The lens driving unit 220 adjusts the position of the imaging lens 140 on the basis of a control signal from an imaging element control unit 170. The lens driving unit 220 can adjust the focal position of the imaging lens 140 depending on a subject by adjusting the position of the imaging lens 140. This makes it possible to autofocus.

The acquisition condition generating unit 160 in the drawing detects the moving velocity including the moving direction and the speed of an object 300 from motion information. The focal position of the imaging lens 140 at an imaging time of the object 300 is calculated on the basis of the moving velocity and is output to the imaging element control unit 170 as a second acquisition condition.

The imaging element control unit 170 generates a control signal depending on the focal position of the imaging lens 140 output from the acquisition condition generating unit 160 and outputs the control signal to the lens driving unit 220. This makes it possible to capture an image in focus on the object 300.

The configuration of the imaging device 10 other than the above is similar to the configuration of the imaging device 10 in the first embodiment of the present disclosure, and thus description thereof is omitted.

As described above, the imaging device 10 according to the fourth embodiment of the present disclosure can adjust the focal position of the imaging lens 140 to the object 300 at timing desired by the user of the imaging device 10. As a result, the image quality of the image can be improved.

### 5. Fifth Embodiment

The imaging device 10 of the first embodiment generates an image of the object 300. Meanwhile, an imaging device 10 according to a fifth embodiment of the present disclosure is different from the above first embodiment in that the position of an object 300 in a generated image is acquired as position information.

### [Configuration of Imaging Device]

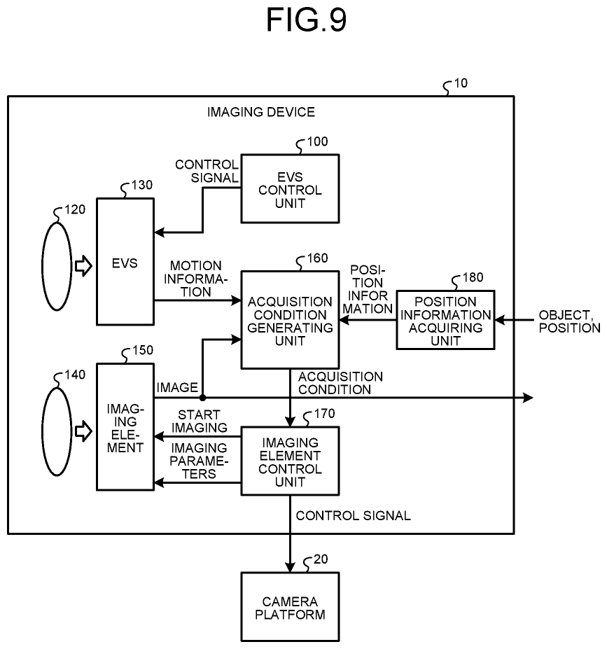

FIG. 9 is a diagram illustrating a configuration example of the imaging device according to the fifth embodiment of the disclosure. The drawing is a block diagram illustrating a configuration example of the imaging device 10, similarly to FIG. 1. The imaging device 10 in the drawing is different from the imaging device 10 in FIG. 1 in further including a camera platform 20.

The camera platform 20 adjusts the direction of the imaging device 10. The camera platform 20 adjusts the direction of the imaging device 10 on the basis of a control signal from an imaging element control unit 170.

The position information acquiring unit 180 in the drawing acquires the position of the object 300 in an image as position information. The position of the object 300 corresponds to, for example, the center of the image. In this case, the imaging device 10 generates and outputs an image in which the object 300 is disposed at the center.

The acquisition condition generating unit 160 detects the position of the object 300 at imaging time on the basis of the motion of the object 300, generates information such as the inclination of the camera platform 20 so that the imaging device 10 faces the position, and outputs the information to the imaging element control unit 170 as a second acquisition condition.

The imaging element control unit 170 generates the control signal on the basis of the information such as the inclination output by the acquisition condition generating unit 160 and outputs the control signal to the camera platform 20. This makes it possible to generate an image in which the object 300 is always disposed at the center.

Note that the configuration of the imaging device 10 is not limited to this example. For example, by setting the cropping size described in FIG. 6, it is also possible to generate an image in which the object 300 is disposed at the center.

The configuration of the imaging device 10 other than the above is similar to the configuration of the imaging device 10 in the first embodiment of the present disclosure, and thus description thereof is omitted.

As described above, the imaging device 10 according to the fifth embodiment of the present disclosure acquires the position of the object 300 in an image as the position information and captures an image. As a result, it is made possible to acquire an image in which the object 300 is positioned as desired by a user of the imaging device 10.

### 6. Sixth Embodiment

The imaging device 10 of the first embodiment generates an image of the object 300 by the imaging element 150. Meanwhile, an imaging device 10 according to a sixth embodiment of the present disclosure is different from that of the first embodiment in that a ranging sensor for measuring the distance to an object 300 is included.

### [Configuration of Imaging Device]

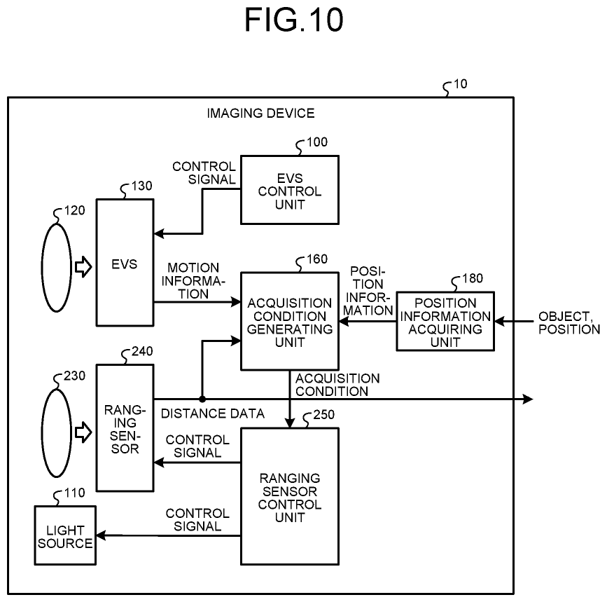

FIG. 10 is a diagram illustrating a configuration example of the imaging device according to the sixth embodiment of the disclosure. The drawing is a block diagram illustrating a configuration example of the imaging device 10, similarly to FIG. 1. The imaging device 10 in the drawing is different from the imaging device 10 in FIG. 1 in including a ranging sensor 240 instead of the imaging element 150 and further including a light source 110 and a ranging sensor control unit 250.

The light source 110 emits light to a subject.

The ranging sensor 240 measures the distance to a subject. The ranging sensor 240 includes an imaging element that detects light emitted by the light source 110 and reflected by the subject. The distance to the subject can be measured by measuring a time from emission of the light from the light source 110 to detection of the reflected light in the ranging sensor 240. As the ranging sensor 240 in the drawing, a sensor that acquires information obtained by imaging distance information as distance data can be used. The distance data is output to an acquisition condition generating unit 160 and to the outside of the imaging device 10. Note that the distance data is an example of the object information described in the claims.

The ranging sensor control unit 250 controls the light source 110 and the ranging sensor 240. The ranging sensor control unit 250 generates a control signal on the basis of an acquisition condition output from the acquisition condition generating unit 160 and outputs the control signal to each of the ranging sensor 240 and the light source 110.

The acquisition condition generating unit 160 in the drawing generates an acquisition condition of distance data including the object 300 on the basis of the distance data generated by the ranging sensor 240 and outputs the acquisition condition to the ranging sensor control unit 250.

The configuration of the imaging device 10 other than the above is similar to the configuration of the imaging device 10 in the first embodiment of the present disclosure, and thus description thereof is omitted.

As described above, the imaging device 10 according to the sixth embodiment of the present disclosure can generate the distance data of the object 300.

### 7. Seventh Embodiment

The imaging device 10 of the sixth embodiment generates the distance data of the object 300. Meanwhile, an imaging device 10 according to a seventh embodiment of the present disclosure is different from that of the sixth embodiment in that an image of the object 300 is further generated.

### [Configuration of Imaging Device]

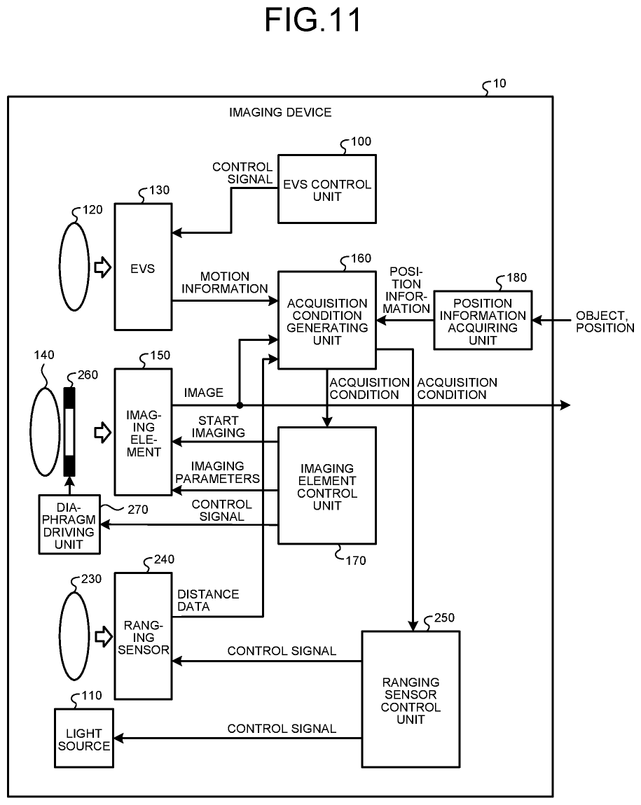

FIG. 11 is a diagram illustrating a configuration example of the imaging device according to the seventh embodiment of the disclosure. The drawing is a block diagram illustrating a configuration example of the imaging device 10, similarly to FIG. 10. The imaging device 10 in the drawing is different from the imaging device 10 in FIG. 10 in further including an imaging element 150, an imaging element control unit 170, a diaphragm 260, and a diaphragm driving unit 270.

The diaphragm 260 narrows down incident light of the imaging element 150.

The diaphragm driving unit 270 adjusts the throttling amount of the diaphragm 260 on the basis of a control signal from the imaging element control unit 170.

A position information acquiring unit 180 in the drawing further acquires blur information.

The acquisition condition generating unit 160 in the drawing calculates the throttling amount at imaging timing of the object 300 from distance data of an object 300 on the basis of the blur information. The acquisition condition generating unit 160 outputs the calculated throttling amount to the imaging element control unit 170 as a second acquisition condition.

The imaging element control unit 170 in the drawing generates a control signal corresponding to the throttling amount output from the acquisition condition generating unit 160 and outputs the control signal to the diaphragm driving unit 270. This makes it possible to generate an image in which a subject other than the object 300 is blurred.

The configuration of the imaging device 10 other than the above is similar to the configuration of the imaging device 10 in the first embodiment of the present disclosure, and thus description thereof is omitted.

As described above, the imaging device 10 according to the seventh embodiment of the present disclosure can generate an image in which the background is blurred as desired by a user of the imaging device 10.

Note that the effects described herein are merely examples and are not limited, and other effects may also be achieved.

Note that the present technology can also have the following configurations.

(1)

An imaging device comprising:
a first sensor that acquires object information, the object information being information regarding an object;
a position information acquiring unit that acquires position information, the position information being information instructing a position of the object at time of acquiring the object information;
a second sensor that acquires motion information, the motion information being information regarding a motion of the object;
an acquisition condition generating unit that generates an acquisition condition of the object information on the basis of the position information that has been acquired and the motion information that has been acquired; and
a control unit that performs control to cause the first sensor to acquire the object information on the basis of the acquisition condition that has been generated.
   (2)

The imaging device according to the above (1),
wherein the acquisition condition generating unit generates an acquisition time of the object information as the acquisition condition.
   (3)

The imaging device according to the above (1),
wherein the first sensor is an imaging element that acquires an image of the object as the object information.
   (4)

The imaging device according to the above (3),
wherein the acquisition condition generating unit further generates a second acquisition condition that is the acquisition condition based on a previously acquired image which is an image acquired before acquisition of the image of the object corresponding to the object information by the first sensor.
   (5)

The imaging device according to the above (4),
wherein the acquisition condition generating unit generates an exposure time related to generation of the image as the second acquisition condition on the basis of the previously acquired image and the motion information.
   (6)

The imaging device according to the above (4),
wherein the acquisition condition generating unit generates sensitivity regarding generation of the image as the second acquisition condition.
   (7)

The imaging device according to the above (4),
wherein the acquisition condition generating unit generates a size of the image as the second acquisition condition.
   (8)

The imaging device according to the above (4), further comprising:
an imaging lens that forms an image of a subject on the first sensor.
   (9)

The imaging device according to the above (8),
wherein the acquisition condition generating unit generates a position of the imaging lens as the second acquisition condition.
   (10)

The imaging device according to the above (8),
wherein the acquisition condition generating unit generates a focal position of the imaging lens as the second acquisition condition.
   (11)

The imaging device according to the above (8), further comprising:
a diaphragm that adjusts a throttling amount of the imaging lens,
wherein the acquisition condition generating unit generates the throttling amount as the second acquisition condition.
   (12)

The imaging device according to the above (4),
wherein the first sensor further generates a moving image that is a plurality of images generated in time series, the plurality of images including an image of the object corresponding to the object information, and the acquisition condition generating unit generates a generation rate of the time-series images in the moving image as the second acquisition condition.
   (13)

The imaging device according to the above (3),
wherein the position information acquiring unit acquires a position of the object in the image as the position information.
   (14)

The imaging device according to the above (3), further comprising:
a ranging sensor that measures a distance to the object,
wherein the acquisition condition generating unit generates an acquisition condition of the object information on the basis of the position information that has been acquired, the motion information that has been acquired, and the distance that has been measured.
   (15)

The imaging device according to any one of the above (1) to (14),
wherein the first sensor is a sensor that acquires information obtained by imaging distance information of the object as the object information.
   (16)

The imaging device according to any one of the above (1) to (14),
wherein the second sensor comprises a plurality of pixels that detects a change in luminance of incident light and acquires, as the motion information, event data including position information of a pixel that has detected the change in luminance.
   (17)

An imaging method comprising:
acquiring position information, the position information being information instructing a position of an object at time of acquiring object information, the object information being information regarding the object;
acquiring motion information, the motion information being information regarding a motion of the object;
generating an acquisition condition of the object information on the basis of the position information that has been acquired and the motion information that has been acquired; and
acquiring the object information on the basis of the acquisition condition that has been generated.

### REFERENCE SIGNS LIST

10 IMAGING DEVICE
20 CAMERA PLATFORM
100 EVS CONTROL UNIT
130 EVS
120, 140, 190, 200 IMAGING LENS
150, 210 IMAGING ELEMENT
160 ACQUISITION CONDITION GENERATING UNIT
170 IMAGING ELEMENT CONTROL UNIT
180 POSITION INFORMATION ACQUIRING UNIT
220 LENS DRIVING UNIT
240 RANGING SENSOR
250 RANGING SENSOR CONTROL UNIT
270 DIAPHRAGM DRIVING UNIT

1. An imaging device comprising:
a first sensor that acquires object information, the object information being information regarding an object;
a position information acquiring unit that acquires position information, the position information being information instructing a position of the object at time of acquiring the object information;
a second sensor that acquires motion information, the motion information being information regarding a motion of the object;
an acquisition condition generating unit that generates an acquisition condition of the object information on the basis of the position information that has been acquired and the motion information that has been acquired; and
a control unit that performs control to cause the first sensor to acquire the object information on the basis of the acquisition condition that has been generated.

2. The imaging device according to claim 1,
wherein the acquisition condition generating unit generates an acquisition time of the object information as the acquisition condition.

3. The imaging device according to claim 1,
wherein the first sensor is an imaging element that acquires an image of the object as the object information.

4. The imaging device according to claim 3,
wherein the acquisition condition generating unit further generates a second acquisition condition that is the acquisition condition based on a previously acquired image which is an image acquired before acquisition of the image of the object corresponding to the object information by the first sensor.

5. The imaging device according to claim 4,
wherein the acquisition condition generating unit generates an exposure time related to generation of the image as the second acquisition condition on the basis of the previously acquired image and the motion information.

6. The imaging device according to claim 4,
wherein the acquisition condition generating unit generates sensitivity regarding generation of the image as the second acquisition condition.

7. The imaging device according to claim 4,
wherein the acquisition condition generating unit generates a size of the image as the second acquisition condition.

8. The imaging device according to claim 4, further comprising:
an imaging lens that forms an image of a subject on the first sensor.

9. The imaging device according to claim 8,
wherein the acquisition condition generating unit generates a position of the imaging lens as the second acquisition condition.

10. The imaging device according to claim 8,
wherein the acquisition condition generating unit generates a focal position of the imaging lens as the second acquisition condition.

11. The imaging device according to claim 8, further comprising:
a diaphragm that adjusts a throttling amount of the imaging lens,
wherein the acquisition condition generating unit generates the throttling amount as the second acquisition condition.

12. The imaging device according to claim 4,
wherein the first sensor further generates a moving image that is a plurality of images generated in time series, the plurality of images including an image of the object corresponding to the object information, and
the acquisition condition generating unit generates a generation rate of the time-series images in the moving image as the second acquisition condition.

13. The imaging device according to claim 3,
wherein the position information acquiring unit acquires a position of the object in the image as the position information.

14. The imaging device according to claim 3, further comprising:
a ranging sensor that measures a distance to the object,
wherein the acquisition condition generating unit generates an acquisition condition of the object information on the basis of the position information that has been acquired, the motion information that has been acquired, and the distance that has been measured.

15. The imaging device according to claim 1,
wherein the first sensor is a sensor that acquires information obtained by imaging distance information of the object as the object information.

16. The imaging device according to claim 1,
wherein the second sensor comprises a plurality of pixels that detects a change in luminance of incident light and acquires, as the motion information, event data including position information of a pixel that has detected the change in luminance.

17. An imaging method comprising:
acquiring position information, the position information being information instructing a position of an object at time of acquiring object information, the object information being information regarding the object;
acquiring motion information, the motion information being information regarding a motion of the object;
generating an acquisition condition of the object information on the basis of the position information that has been acquired and the motion information that has been acquired; and
acquiring the object information on the basis of the acquisition condition that has been generated.
